(19) United States
(12) Patent Application Publication
(10) Pub. No.: US 2017/0259978 A1
(43) Pub. Date: Sep. 14, 2017

(54) Tabbed Film With Transverse Easy Open Feature

(71) Applicant: Selig Sealing Products, Inc., Forrest, IL (US)

(72) Inventors: Rafael Zamora, Oberglatt (CH); Timea Cilmi, Oberglatt (CH)

(21) Appl. No.: 15/452,191

(22) Filed: Mar. 7, 2017

Related U.S. Application Data
(60) Provisional application No. 62/384,828, filed on Sep. 8, 2016.
(60) Provisional application No. 62/305,262, filed on Mar. 8, 2016.

(51) Int. Cl. B65D 75/58; B65D 65/40; B65D 75/04; B32B 7/12; B32B 27/34; B32B 7/06; B32B 3/08; B32B 27/08; B32B 27/32; B32B 27/36; B65D 65/14; B32B 1/02

(52) U.S. Cl. CPC B65D 75/5855; B65D 65/14; B65D 65/40; B65D 75/04; B32B 7/12; B32B 1/02; B32B 7/06; B32B 3/085; B32B 27/08; B32B 27/32; B32B 27/36; B32B 27/34; B32B 2250/24; B32B 2250/04; B32B 2255/10; B32B 2255/26; B32B 2307/748; B32B 2439/40; B32B 2439/70; B32B 2307/7242

(57) ABSTRACT

A packaging film including an upper tab layer intermittently bonded to layers below it along a machine or longitudinal direction and suitable for forming a transverse easy opening feature in a formed package.

### CROSS-REFERENCE TO RELATED APPLICATIONS

This application claims benefit of United States Provisional Application No. 62/384,828, filed Sep. 8, 2016, and United States Provisional Application No. 62/305,262, filed Mar. 8, 2016.

### FIELD

The disclosure relates to film for packaging, and more particularly, to film for packaging having a transverse easy open feature for the formed package.

### BACKGROUND

Films suitable for packaging, such as flow packs, form fill and seal packages, or other pouches, commonly have one or more transverse and/or longitudinal seals, such as heat seals, cold seals, and the like. To open a formed package, users can tear or peel apart one of the seals to gain access to the container contents. This can often destroy the package or result in varying or inconsistent opening experience for the consumer because the package may peel or tear differently each time the consumer attempts to open the package by tearing or peeling the package films apart.

Attempts have been made to form a package film to include features to make opening more consistent and predictable. For example, some prior methods involve laser cutting, perforations, die cuts, seams, and the like to enable more predictability on the packaging opening by defining directed pathways for film and packaging opening and tearing. These approaches, however, have the shortcoming that such directed pathways may affect the permeability of the package because the cuts or other pathway features can extend wholly or partially through the package film. If not extending through the package films, the cuts may still expose inner film layers that are more permeable to gases and oxygen. With these prior approaches, therefore, the package and film may not necessarily be able to maintain a hermetic seal or be capable of retaining an inert atmosphere within the package because the cuts or perforations either expose the interior of the package or expose film layers that are gas permeable.

### BRIEF DESCRIPTION OF THE DRAWINGS

FIG. 1 is a longitudinal or machine direction cross-sectional view of an exemplary tabbed packaging film providing a transverse easy open feature for the formed package;

FIG. 2 is another longitudinal or machine direction cross-sectional view of an exemplary tabbed packaging film showing the tab lifted upwardly (at an interface between a functional release layer and a tab adhesive layer) at opposite ends of the package where the tab is generally formed along a transverse seal of the package;

FIG. 3 is a perspective cross-sectional view, partially exploded, showing an exemplary tabbed packaging film;

FIG. 4 is a perspective view of a formed package showing an elongate gripping tab being used to peel open the transverse seal of the package;

FIG. 5 is a is a longitudinal or machine direction cross-sectional view of an exemplary tabbed packaging film providing a transverse easy open feature for the formed package;

FIG. 6 is another longitudinal or machine direction cross-sectional view of an exemplary tabbed packaging film showing the tab lifted upwardly at opposite ends of the package where the tab is generally formed along a transverse seal of the package; and

FIG. 7 is a perspective cross-sectional view, partially exploded, showing an exemplary tabbed packaging film.

### DETAILED DESCRIPTION

A packaging film is described herein that includes an upper tab laminate at least partially bonded to a base packaging laminate and configured to form a transverse easy opening feature when the film is formed into package. In one aspect or embodiment, the packaging film is a multi-layer laminate where the upper tab laminate includes a tab film or tab layer adhered to the base packaging laminate. The packaging film may include one or more transverse release features intermittently spaced along the machine or longitudinal direction that form an interface within the multi-layer laminate enabling the tab film or tab layer to intermittently release from the layers below it, which creates an transverse easy open feature (such as an elongate gripping tab) in the subsequently formed package. In another form, the packaging film may be partially laminated so that release features are not needed. For example, adhesive may be applied in a transverse direction at certain locations and/or may be registered partially laminated.

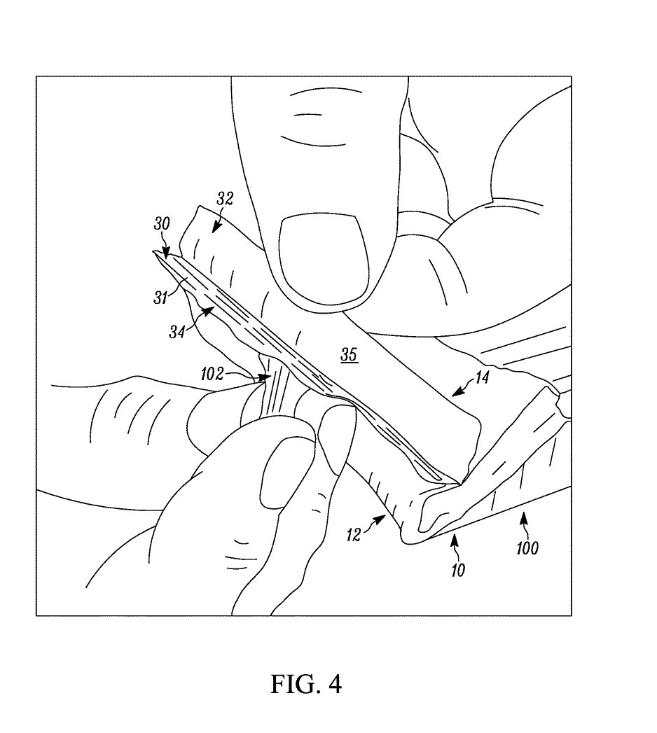

To form the elongate gripping tab in the resultant package, a portion of the tab film or tab layer, for example, does not adhere or bond to the layers below it within the multi-layer laminate. In a formed package, this elongate gripping tab is preferably associated with or aligned with a transverse package seal, such a transverse package heat seal or cold seal at the top and/or bottom of the formed package. The elongate gripping tab provides an easy opening feature for a consumer to grip in one hand and peel a package seal open in a predictable manner while the other hand, for example, holds a fin or longitudinal seal of the package (as generally exemplified in FIG. 4 for instance).

In one aspect or embodiment, the base packaging laminate may include at least a lower seal layer and one or more polymer support layer(s) bonded to the lower seal layer. In one approach, the base packaging laminate may be any common packaging film suitable for flow packaging and/or horizontal or vertical form fill and seal packaging. Preferably, the one or more polymer support layer(s) is a film(s) capable of providing support and structure, such as polyester (for instance, polyethylene terephthalate or PET), oriented polypropylene, oriented polyamide, nylons, polyethylene naphthalate (PEN), combinations thereof, and copolymers thereof. The lower seal layer may be any material suitable to form a heat seal, cold seal, or the like.

In another aspect or embodiment, the tab film or tab layer is intermittently bonded, in the machine or longitudinal direction of the film, to a top surface of the base packaging laminate. The tab film or tab layer, in combination with the transverse release feature and/or partial lamination, forms the elongate gripping tab when the film is formed into the package. As discussed more below, the transverse release features may be transverse release strips or relatively narrow transverse release layers/coatings extending or applied transversely to the film (that is, preferably perpendicular to the machine or longitudinal direction of the film) in a spaced or intermittent arrangement on the top surface of the base packaging laminate and/or just a transverse area without adhesive and without release strips, as in the case of partial lamination. In one form, the release strips form the elongate gripping tab because it has surface characteristics at an upper interface thereof that generally prevent or limit a portion of the tab film or tab layer (and any layers associated therewith) from bonding to the layers below and, in particular, to the upper surface of the transverse release strips themselves. In another form, instead of release strips, partial lamination is used without release strips whereby layers are partially adhered, such as at multiple locations between the layers.

Thus, the packaging films herein provide a laminate structure having a longitudinally spaced portion in which the tab layer is not bonded to the layers below within the laminate structure. Upon forming into a common flow pack or package form a vertical or horizontal film, form and seal machine, the film's spaced tab portions are arranged and configured to form the elongate transverse gripping tab along the cross seals at the top and/or bottom of a package. The gripping tab pivots upwardly and away from the seal to provide a convenient feature for a consumer to grasp and peel open the heat or cold seal of the package as generally shown in FIG. 4.

Advantageously, the film structures herein enable the elongate gripping tab to conveniently and more predictability open a formed package without the use of laser cuts, perforations, die cuts, weakening areas, seams, or other deformations, cuts, pin holes and the like in the package that can be detrimental to the ability to maintain an hermetic or air tight package or pouch. To this end, the formed packages prepared out of the packaging films herein can be filled with an inert atmosphere, such as nitrogen or other inert gas, for food protection. Preferably, the film (and tab layer thereof) forms a sturdy tab structure with a stronger bond to the base packaging laminate than a heat seal or cold seal bond in a formed package. The films and packages formed therefrom preferably have top-mounted tabs (i.e., above the base packaging laminate) that are defined wholly within a perimeter of the packaging film and also any formed package. The elongate gripping tabs may be formed by the transverse release feature in the form of a partial release layer or strip that prevents the tab film and adhesive from bonding to the layers below it within the film structure and within the formed package.

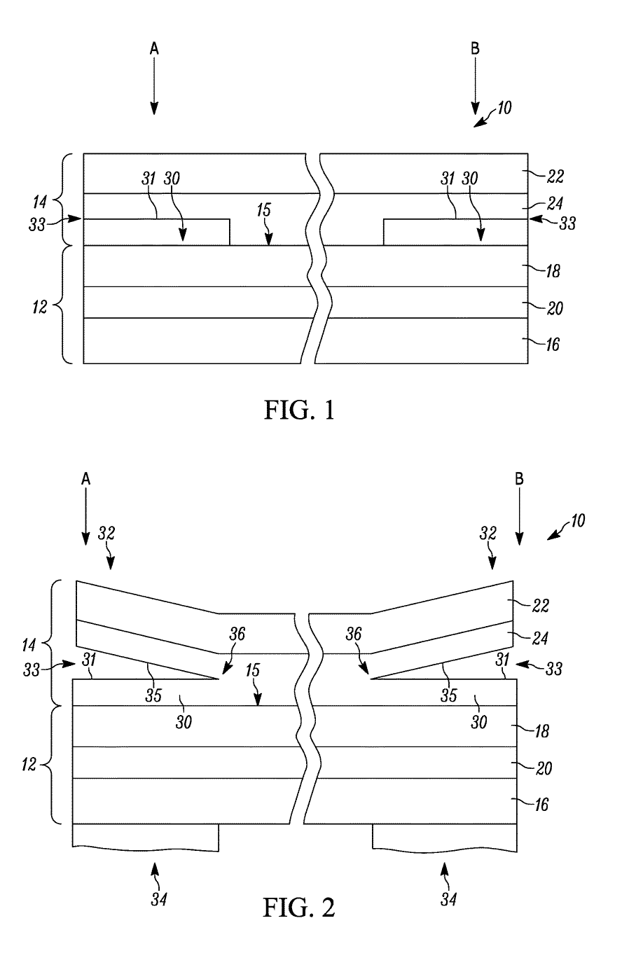

Turning to more of the details, FIGS. 1-3 illustrate machine (down web) or longitudinal direction cross-sectional views of an exemplary packaging film 10 having a built-in tab functionality for the formed package. The film 10 includes a lower or base packaging film or laminate 12 and an upper tab film or laminate 14 that is at least partially bonded to an upper surface 15 of the base packaging laminate 12.

The base packaging laminate 12 includes one or more layers suitable for flow pack packaging or common vertical or horizontal form, film and seal machines. The base packaging laminate 12 may include at least a lower seal layer 16 and one or more upper or polymer support layer(s) 18. There may also be an adhesive tie layer 20 bonding the polymer support layer(s) 18 to the lower seal layer 16.

The upper tab laminate 14 is one or more layers including at least a tab film or tab layer 22 that is at least partially bonded by an adhesive layer 24 to the top surface 15 of the base packaging laminate 12. Spaced in the machine or longitudinal direction of the film 10, transverse functional layers or transverse release features, such as transverse release layers or strips 30, are positioned or applied in a cross web direction. As discussed more below, the release layers 30 have an upper surface 31 with release characteristics or wetting characteristics to limit or prevent a bond with the layers above it or at least permit the release or debonding of the tab layer 22 (and any associated adhesive, such as layer 24) from bonding to the upper surface 31 of the release layer 30 as generally shown in FIG. 2. For example, the surface or wetting characteristics of the release layer 30 limit or prevent the lower surface 35 of the adhesive layer 24 from bonding to the strip 30. This built-in tab functionality is achieved without any laser cuts, perforations, die cuts, pin holes, deformations, seams, or other formed pathways in any of the film 10 layers, which as discussed above, provides a more robust film capable of forming hermetic packages.

The lower seal layer 16 may be any heat seal or cold seal material used in packaging films. Examples include polyethylene, oriented polyethylene, polyolefin resins, acrylate resins, cold seal adhesives, heat seal adhesives, and the like. Exemplary cold seal adhesives may be from about 2 microns to about 5 microns thick. Exemplary heat seal adhesives may be about 10 to about 100 microns thick.

The one or more upper polymer support layers 18 may be any polymer film or layer that provides support and/or structure to the base packaging laminate 12. Examples includes polyesters (for instance, polyethylene terephthalate or PET), nylon, oriented polypropylene, oriented polyamide, nylon, polyethylene naphthalate (PEN), combinations thereof, and copolymers thereof. If more than one support layer is included, there may be thin adhesive tie layers therebetween. The polymer support layers may be one or more layers that is about 5 to about 50 microns thick. In one approach, the polymer support layers may be about 10 to about 15 microns, and preferably 12 microns. The film is preferably PET and can be plain PET or chemically treated.

The adhesive tie layer 20 within the base packaging laminate may be any suitable adhesive that may bond the support polymer layer 18 to the lower seal layer 16 (or any other layers in the base packaging laminate). In some approaches, the tie layer may be about 3 to about a 15 microns (or less) adhesive, such as a coated ethylene vinyl acetate (EVA), polyolefins, 2-component polyurethane, ethylene acrylic acid copolymers, curable two part urethane adhesives, epoxy adhesives, ethylene methacrylate copolymers and the like bonding materials.

The transverse release layer 30 may be a coating or application of a release material, such as a release lacquer or varnish that, in one approach, may include or be a polyamide composition typically prepared from a dimeric fatty acid as a carboxyl component and a polyamine, such as a diamine or triamine as an amine component. Suitable polyamides may be prepared by reacting a polycarboxylic acid with a polyamine, commonly in the presence of a suitable catalyst. The carboxylic groups and amine groups react with each other and form amide groups and result in a polymer, having suitable release properties, with a structural base of:

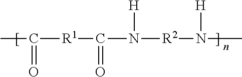

Where R1 and R2 are carbon chains and, preferably, aliphatic carbon chains with optional substitution thereon. In some approaches, the release layer may also include various additives, such as waxes, fatty acid amide components, paraffin, silicones and the like.

In other approaches, the transverse release layer may be a release lacquer including a blend of the above polyamide or other polyamide and nitrocellulose or possibly just nitrocellulose. The release layer may also include high levels of a slip agent, such as fatty amides, erucamides, oleamides, and the like. In one approach, release of the adhesive from the upper surface of the release layer may be due to high levels of slip additive at the upper surface of the release layer and, in some approaches, a general incompatibility of the selected adhesive with the release layer.

The transverse release layer 30 may be strip coated or printed on the web at a spacing of about 1 to about 15 cm apart. The layer 30 may be up to about 3 cm wide, but the spacing and width may vary as needed for particular applications. In some approaches, the transverse release layer 30 may correspond with or overlap any formed transverse heat or cold seal in the resultant formed package. In one approach, the release lacquer is solvent based, but may also be a water based composition as needed for a particular application. Alternatively, the release layer be other materials, such as silicone, fluorocarbon polymers, siloxanes (such as PDMS-polydimethylsiloxane), or wax. Without wishing to be limited by theory, the release layer enables release or de-bonding of the adhesive layer above it because there is a chemically incompatibility with the adhesives and it has a surface that minimizes or avoids a permanent physical bond with the adhesive, such that there is no intermingling of the adhesive polymer chains with the upper surface of the release layer.

The upper tab laminate 14 includes at least the tab layer or tab film 22 that may be any polymer having a sufficient structural rigidity to provide a gripping tab. Suitable materials may be polyesters (such as polyethylene terephthalate or PET), oriented polyolefin (such as oriented polypropylene), nylon, polyethylene naphthalate (PEN), combinations thereof, and copolymers thereof. This layer may be about 12 to about 50 microns thick.

By one approach, the upper tab laminate may be free of additives and compatible with the adhesive layer 24. In another approach, if the lower seal layer 16 is a cold seal adhesive, then the upper laminate 14 top surface preferably also includes release properties to minimize or prevent blocking of the film when wound in a reel. In one approach, the release function may be achieved by a laminate of a polypropylene homopolymer (and another layer.) The polypropylene homopolymer is highly crystalline, which typically does not allow an easy bond of its surfaces. For instance, the laminate may include an outer oriented polypropylene homopolymer, approximately 15 to 25 microns thick, and an inner PET for good adhesion to the adhesive layer 24. Alternatively, if the lower seal layer 16 is a heat seal, then a mono film as the upper tab laminate may be sufficient.

Adhesive layer 24 bonds fully to a lower surface of layer 22, but only partially bonds the tab film 22 to the top surface 15 of the base packaging laminate 12 (in view of the functional release layer 30 as discussed above). The adhesive 24 forms a stronger bond between the tab film 22 and top surface 15 of the base packaging laminate 12 than any formed cold or heat seal in the resultant package so that when a tab 32 (see FIG. 2) is pulled, the heat seal or cold seal separates before the tab layer 22 delaminates from the film in the areas between the release strips 30. By one approach, the adhesive 24 may be a polyurethane adhesive such as those formed with an isocyanate bonded to a polyol through a carbonate bond. By one approach, the polyurethane is a solvent based adhesive applied using a gravure roller, but may be applied using other conventional adhesive coating methods. Other suitable adhesives may include ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials. The adhesive may be solvent based, but may also be solventless as needed for a particular application. By one approach, the solvent may be ethyl acetate, but others may be used as needed for a particular application. In one approach, the adhesive is a one-part polyurethane adhesive that forms a strong bond to plain PET, aluminum foil, and polyolefin polymers (without additives), but forms a weak bond to the release layer 30 as mentioned above.

In another approach or embodiment, the adhesive 24 may be or include EVA. By this approach, the EVA may have a vinyl acetate content of about 20 to about 28 percent with the remaining monomer being ethylene in order to achieve the bond strengths. In some approaches, a vinyl acetate content lower than 20 percent is insufficient to form the robust structures described herein.

After application and bonding of adhesive 24 to form the bond between layer 22 and the top surface 15 of polymer support layer 18, the adhesive 24 becomes fully cured. In some approaches, full curing may take between 1 and 10 days, in other approaches, about 5 and 10 days, and in yet other approaches, between 7 and 10 days. After curing, there is no bond between the top surface 31 of the release strip 30 and the underside 35 of the cured adhesive layer 24, but a strong bond is formed between the adhesive layer 24 and the lower surface of the film 22 and the top surface 15 of the base packaging laminate 12. In this regard, in view of the adhesive being cured, the underside 35 of the formed tab 32 (see FIG. 2) tends not to be sticky to the touch.

Turning now more specifically to FIG. 2, after the film 10 is formed into a package (with exemplary top and bottom cold or heat seals 34), the functional or transverse release strip 30 enables the layers above it to pivot upwardly at a hinge or joint 36 to form an elongate gripping tab 32. To this end, there is an interface 33 between the top surface 31 of the release layer 30 and the lower surface 35 of the adhesive layer 24 directly above and adjacent thereto in which bonding is limited or prevented so that the layers in the tab film 22 and associated adhesive 24 can separate from the release layer 30 and form the tab 32 about the hinge or pivot joint 36 when the film is formed into a package.

In the context of a polyurethane adhesive layer 24 and a polyamide release layer 30, there is a polyamide-polyurethane interface 33 in which the surface wetting characteristics of the polyamide release layer hinder or at least result in very low bonding between the polyurethane in layer 24 and the upper surface 31 of the polyamide. This interface enables the release or debonding of the layers in the tab film 22 and associated adhesive 24 to separate and pivot upwardly from the release strip 30 to form the tab 32 as exemplified in FIG. 2. In addition, there may be slip additives at the interface or upper surface of the release layer.

In one approach, there may be a weak bond between the lower surface 35 of the adhesive 24 and the top surface 31 of the release strip 30 that is, preferably, about 0 grams/centimeter. Preferably, the adhesive 24 forms a weak bond with materials having the above mentioned slip agents. On the other hand, a strong bond between the adhesive 24 and the top surface 15 of the base packaging laminate 12 is formed as long as the top surface 15 of the base packaging laminate is free of or substantially free of slip agents. Additionally, the top surface of the base packaging laminate may be a crystalline polymer or may be partially crystalline polymer.

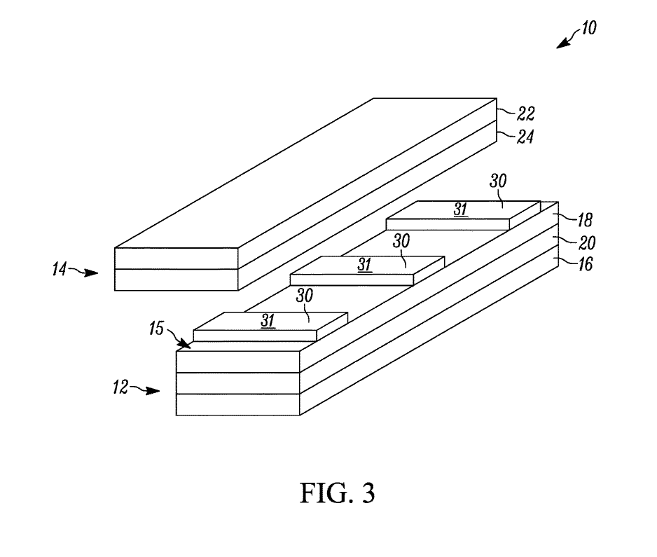

As shown in FIG. 3, the release strip 30 is transversely applied, coated, or printed in a spaced or intermittent arrangement in the machine or longitudinal direction of the film 10 between the base packaging film 12 and the tab laminate 14. Preferably, the release layer 30 is applied directly to the top surface 15 of the base packaging laminate 12, but it could also be applied to the bottom layer of the tab film 14 if needed for a particular application. By one approach, the release strip 30 is applied by using a gravure coating roller or other conventional coating or printing method. The release strips 30 are bonded to the top surface 15 of the base packaging laminate.

Without wishing to be limited by theory, the release layer 30 is effective to build an intermingling bond with the layers below it, which may be partially crystalline polymers. The selected adhesive layer 24 may do the same with partially crystalline polymers. On the other hand, the adhesive layer 24 does not form a good bond with the release layer 30 having slip additives therein and also does not match chemically with certain active groups that are sized and positioned to not physically penetrate with the molecules of the release layer 30.

Upon forming into a package and as generally shown in the exemplary cut lines A and B in FIGS. 1 and 2, the film 10 may be processed in a typical flow pack or vertical/horizontal film, flow and package machine where the film 10 is cut along A and B to form the package between these cut lines. Preferably, the cut lines A and B are approximately intermediate the length of the release layer 30 so that the formed tab 32 corresponds to or is at least aligned with any transverse heat or cold seal (such as that exemplified in FIG. 3 at reference numbers 34).

FIG. 4 illustrates a formed package 100 using the packaging films 10 of the present disclosure. The package 100 includes a transverse seal 34 (such as a cold or heat seal) and a tab 32 for use by a consumer to grasp and peel open the seal 34 as exemplified in FIG. 4. As shown in this approach, the package 100 also includes a fin or longitudinal seal 102.

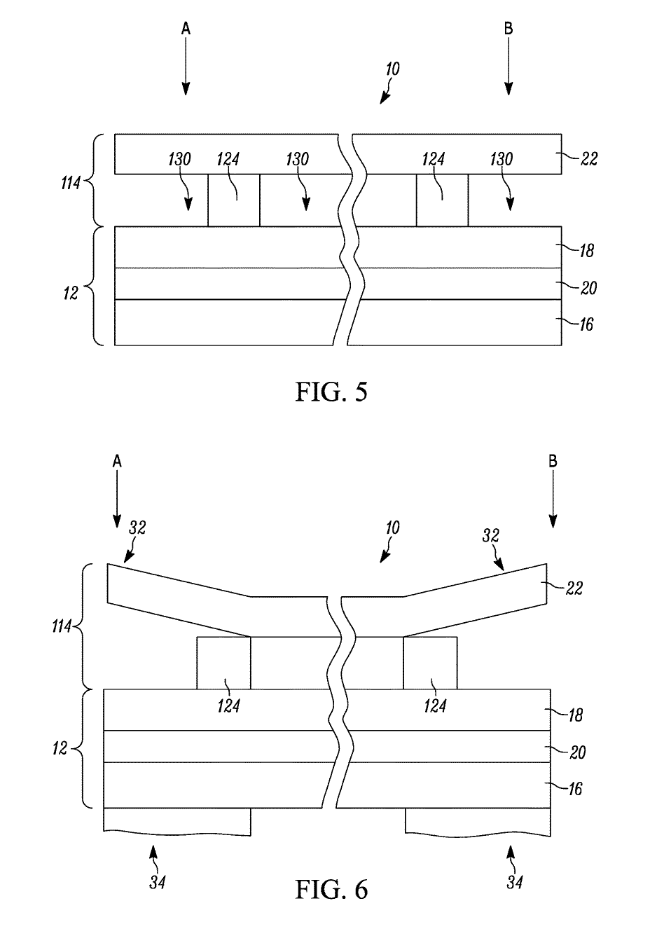

Another embodiment of the film 10 is shown in FIGS. 5 and 6. These figures illustrate an embodiment that does not include release layers, but instead incorporates partial lamination. It should be appreciated that similar reference numbers are used herein for similar features. Further, in some forms, the positioning and size of the release layers discussed above can be formed as unbonded regions as will be discussed below.

Turning to FIG. 5, an adhesive 124 is selectively positioned between the base packaging laminate 12 and the upper tab 22. The upper tab 22 may also take the form of a laminate 114 having multiple layers such that the adhesive 124 is positioned between the upper laminate and the base packaging laminate 12. The adhesive can be assembled such that it forms part of the upper laminate with the upper tab 22 and/or may be assembled such that it can form an upper surface of the base packaging laminate 12.

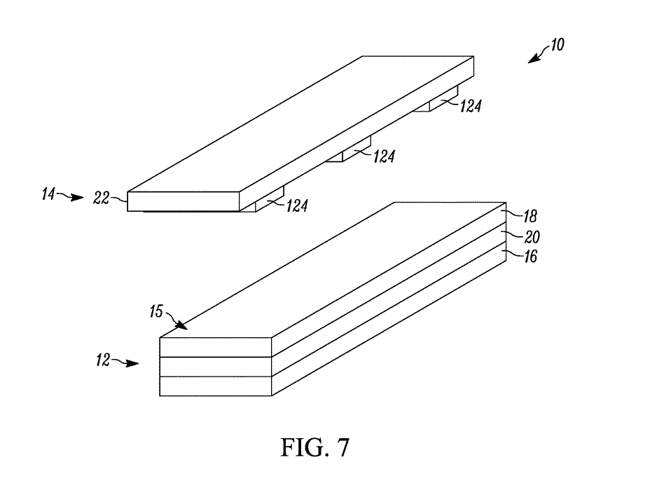

The adhesive 124 is applied in a manner such that it forms a partial lamination between the upper laminate 114 and/or the upper tab 22 and the base packaging laminate 12. In this regard, the adhesive 124 can be applied in a continuous manner, such as in a transverse direction, and/or in a discontinuous manner. In one form, the adhesive 124 forms a plurality of strips, as shown in FIG. 7. The adhesive can be applied such that there are any number of strips and/or points of adhesive 124 thereby creating portions of unbonded areas 130.

It will be understood that various changes in the details, materials, and arrangements of the process, laminates, laminate/substrate assemblies, and combinations thereof, which have been herein described and illustrated in order to explain the nature of the products and methods may be made by those skilled in the art within the principle and scope of the embodied products and methods as expressed in the appended claims. For example, the laminates and assemblies may include other layers within the laminate and between the various layers shown and described as needed for a particular application. Adhesive layers not shown in the Figures may also be used, if needed, to secure various layers together. Unless otherwise stated herein, all parts, percentages, and ratios are by weight.

What is claimed is:

1. A film for forming a package with at least one transverse elongate tab, the film comprising:
a base packaging laminate including a lower seal layer and at least one polymer support layer bonded thereto;
an upper tab laminate at least partially bonded to the base packaging laminate, the upper tab laminate including a tab film and adhesive for partially bonding the tab film to a top surface of the base packaging laminate;
one or more transverse release strips spaced along a machine direction of the film, the one or more transverse release strip positioned between the adhesive and the base packaging laminate; and
a transverse portion of a lower surface of the tab film is not adhesively bonded to an upper surface of the one or more transverse release strips so that the transverse portion creates an elongate gripping tab when the film is formed into a package, wherein the elongate gripping tab is defined wholly within a perimeter of the formed package.

2. The film of claim 1, wherein the lower seal layer includes a polyethylene, polypropylene, acrylic resin, co-polyester resins, ethylene vinyl acetate resins, ethylene methacrylate resins, and combinations thereof.

3. The film of claim 1, wherein the lower seal layer includes a cold seal adhesive.

4. The film of claim 1, wherein the one or more transverse release strips are bonded to an upper surface of the base packaging laminate.

5. The film of claim 1, wherein the at least one polymer support layer includes polyester, oriented polyolefin, oriented polyamide, combinations thereof, and copolymers thereof.

6. The film of claim 1, wherein the tab film is polyester or oriented polyolefin.

7. The film of claim 6, wherein the polyester is polyethylene terephthalate and the oriented polyolefin is oriented polypropylene.

8. The film of claim 1, wherein the one or more transverse release strips include or are based on a polyamide, nitrocellulose, and combinations thereof and may include slip agents.

9. The film of claim 8, wherein the polyamide composition includes a polyamide with a main structural unit selected from the group consisting of at least one dimeric fatty acid, such as C10 to C30 carboxylic acid and at least one polyamine, such as diamines, triamines, and mixtures thereof.

10. The film of claim 1, wherein the adhesive for adhesively bonding the tab film to a top surface of the base packaging laminate includes a at least one of a polyurethane-based composition, coated ethylene vinyl acetate, polyolefins, ethylene acrylic copolymers, epoxy adhesives, ethylene methacrylate copolymers, and combinations thereof.

11. The film of claim 1, further comprising a polyamide-urethane interface between a top surface of the one or more transverse release strips and a bottom surface of the adhesive, the polyamide-urethane interface permitting the release of the bottom surface of the adhesive from the top surface of the one or more transverse release strips to create the elongate gripping tab when the film is formed into the package.

12. A package formed by the film of claim 1, the package including at least one transverse elongate tab.

13. A film for forming a package with at least one transverse elongate tab, the film comprising:
a base packaging laminate including a lower seal layer and at least one polymer support layer bonded thereto;
an upper tab laminate partially bonded to the base packaging laminate, the upper tab laminate including a tab film and adhesive for partially bonding the tab film to a top surface of the base packaging laminate, the adhesive being positioned in selective areas less than an entire surface area of the upper tab laminate to form the partial bond between the upper tab laminate and the base packaging laminate; and
a transverse portion of a lower surface of the tab film is not adhesively bonded to an upper surface of the base packaging laminate so that the transverse portion creates an elongate gripping tab when the film is formed into a package, wherein the elongate gripping tab is defined wholly within a perimeter of the formed package.

14. The film of claim 13, wherein the lower seal layer includes a polyethylene, polypropylene, acrylic resin, co-polyester resins, ethylene vinyl acetate resins, ethylene methacrylate resins, and combinations thereof.

15. The film of claim 13, wherein the lower seal layer includes a cold seal adhesive.

16. The film of claim 13, wherein the one or more transverse release strips are bonded to an upper surface of the base packaging laminate.

17. The film of claim 13, wherein the at least one polymer support layer includes polyester, oriented polyolefin, oriented polyamide, combinations thereof, and copolymers thereof.

18. The film of claim 13, wherein the tab film is polyester or oriented polyolefin.

19. The film of claim 18, wherein the polyester is polyethylene terephthalate and the oriented polyolefin is oriented polypropylene.
